(19) United States
(12) Patent Application Publication
(10) Pub. No.: US 2026/0366616 A1
(43) Pub. Date: Nov. 19, 2026

(54) CONTROL SYSTEM WITH LOW HEIGHT X-Y SHIFTER FOR AUTOMATED MANUAL TRANSMISSION

(71) Applicant: Eaton Intelligent Power Limited, Dublin (IE)

(72) Inventors: Marcello Sagradi, Sao Paulo (BR); Sebastiao Joel Dias, Sao Paulo (BR); Manish Kapse, Bhiwapur, Manharashtra (IN)

(21) Appl. No.: 19/514,965

(22) PCT Filed: Aug. 30, 2025
(86) PCT No.: PCT/IB2024/058461

§ 371 Date: Feb. 27, 2026

Related U.S. Application Data
(60) Provisional application No. 63/536,155, filed on Sep. 1, 2023.

(51) Int. Cl. F16H 63/20; F16H 61/28; F16H 61/32; F16H 63/00; F16H 63/30

(52) U.S. Cl. CPC F16H 63/20; F16H 61/2807; F16H 61/32; F16H 2061/2884; F16H 2063/005; F16H 2063/3079

(57) ABSTRACT

A control system for an automated manual transmission includes a base box with a plurality of shift rails configured to move a respective one of a plurality of gear engagement clutches of the automated manual transmission. Each one of the plurality of shift rails extends along a respective shift rail longitudinal axis. The control system further includes an x-y shifter with a master rail extending along a master rail longitudinal axis. A first actuator is configured to rotate the master rail about the master rail longitudinal axis. A second actuator is configured to translate the master rail along the master rail longitudinal axis. Rotating the master rail about the master rail longitudinal axis causes the master rail to engage with one of the plurality of shift rails. Translating the master rail along the master rail longitudinal axis causes the master rail to move the one engaged shift rail of the plurality of shift rails along its respective shift rail longitudinal axis.

### CROSS-REFERENCE TO RELATED APPLICATION

This application claims priority to U.S. Provisional Patent Application No. 63/536,155 filed on Sep. 1, 2023, the disclosure of which is incorporated by reference herein in its entirety.

### FIELD OF INVENTION

The present disclosure is directed to vehicle transmission systems. More particularly, the present disclosure is directed to a control system with a low height x-y shifter for an automated manual transmission.

### BACKGROUND

Automatic transmissions and manual transmissions are known. Automatic transmissions generally include planetary gears, hydraulic controls, and a torque converter. In use, an operator uses a transmission interface (e.g., shift lever) to select a “drive position” (forward or reverse), and the automatic transmission automatically selects appropriate gear ratios without further input from the operator. Manual transmissions generally include a plurality of constant mesh gears mounted on different shafts (i.e., input shaft, countershaft, output shaft) and a clutch. In use, an operator must continually evaluate operating conditions to decide appropriate gear ratios and must also operate a clutch while selecting those gear ratios.

While manual transmissions are generally cheaper and more robust, an operator of a manual transmission equipped vehicle must have knowledge of how to assess what the appropriate gear ratio is for various operating conditions, how to operate the clutch, and how to shift between gear ratios. This may require significant training and practice.

Automated manual transmissions have been developed in order to provide the benefits of a traditional manual transmission while overcoming some of the foregoing issues regarding operator training and practice. Automated manual transmissions operate in a fashion similar to traditional manual transmissions but utilize electronics, actuators, and other components to automate various operations, such as operating the clutch. Among one of those components is the x-y shifter. Known x-y shifters are deficient, however, in that they are too complex, too expensive, or too large for certain applications.

### SUMMARY OF THE INVENTION

In one embodiment, a control system for an automated manual transmission includes a base box with a plurality of shift rails configured to move a respective one of a plurality of gear engagement clutches of the automated manual transmission. Each one of the plurality of shift rails extends along a respective shift rail longitudinal axis. The control system further includes an x-y shifter with a master rail extending along a master rail longitudinal axis. A first actuator is configured to rotate the master rail about the master rail longitudinal axis. A second actuator is configured to translate the master rail along the master rail longitudinal axis. Rotating the master rail about the master rail longitudinal axis causes the master rail to engage with one of the plurality of shift rails. Translating the master rail along the master rail longitudinal axis causes the master rail to move the one engaged shift rail of the plurality of shift rails along its respective shift rail longitudinal axis.

In another embodiment, a method of shifting an automated manual transmission having a plurality of gear engagement clutches includes providing a base box and an x-y shifter. The base box has a plurality of shift rails configured to move a respective one of the plurality of gear engagement clutches. Each one of the plurality of shift rails extends along a respective shift rail longitudinal axis. The x-y shifter has a master rail, a first actuator, and a second actuator. The first actuator is activated to rotate the master rail about the master rail longitudinal axis to cause the master rail to engage with one of the plurality of shift rails. The second actuator is activated to translate the master rail along the master rail longitudinal axis to cause the master rail to translate the one engaged shift rail of the plurality of shift rails along its respective shift rail longitudinal axis.

### BRIEF DESCRIPTION OF DRAWINGS

In the accompanying drawings, structures are illustrated that, together with the detailed description provided below, describe exemplary embodiments of the claimed invention. Like elements are identified with the same reference numerals. It should be understood that elements shown as a single component may be replaced with multiple components, and elements shown as multiple components may be replaced with a single component. The drawings are not to scale and the proportion of certain elements may be exaggerated for the purpose of illustration.

FIG. 1 is a perspective view of an exemplary control system for an automated manual transmission, the control system including an x-y shifter and a base box,

FIG. 2 is a partially exploded perspective view of the control system of FIG. 1 showing part of the x-y shifter separated from the base box,

FIG. 3A is a perspective view of part of the control system of FIG. 1 showing part of the x-y shifter and part of the base box, with some components omitted for clarity,

FIG. 3B is an exploded view of the part of the control system shown in FIG. 3A,

FIG. 3C is an opposite perspective view of the part of the control system shown in FIG. 3A,

FIG. 3D is a top view of the part of the control system shown in FIG. 3A,

FIG. 3E is a bottom view of the part of the control system shown in FIG. 3A,

FIG. 4 is a perspective view of part of the control system of FIG. 1 showing part of the x-y shifter and the base box, with some components omitted for clarity,

FIG. 5 is another perspective view of part of the control system of FIG. 1 showing part of the x-y shifter, with some components omitted for clarity,

FIG. 6 is a schematic showing paths of communication between a control system electronic control unit and parts of the control system of FIG. 1,

FIG. 7A is a perspective view of an exemplary embodiment of an automated manual transmission that may utilize the control system of FIG. 1,

FIG. 7B is another perspective view of the automated manual transmission of FIG. 7A,

FIG. 8 is a cross-sectional view of the automated manual transmission shown in FIGS. 7A and 7B,

FIG. 9 is a perspective view of an exemplary embodiment of a primary clutch for use with the automated manual transmission shown in FIGS. 7A, 7B, and 8,

FIG. 10 is a perspective view of an exemplary embodiment of an inertia brake for use with the automated manual transmission shown in FIGS. 7A, 7B, and 8,

FIG. 11 is a perspective view of an exemplary embodiment of a pneumatic linear clutch actuator for use with the automated manual transmission shown in FIGS. 7A, 7B, and 8,

FIG. 12A is a perspective view of an exemplary embodiment of a transmission electronic control unit for use with the automated manual transmission shown in FIGS. 7A, 7B, and 8,

FIG. 12B is a schematic showing paths of communication between a transmission control system electronic control unit and the parts of the automated manual transmission shown in FIGS. 7A, 7B, and 8,

FIG. 13A is a side view of a first side of the automated manual transmission shown in FIGS. 7A, 7B, and 8, and

FIG. 13B is a perspective view of a second side of the automated manual transmission shown in FIGS. 7A, 7B, and 8.

### DETAILED DESCRIPTION

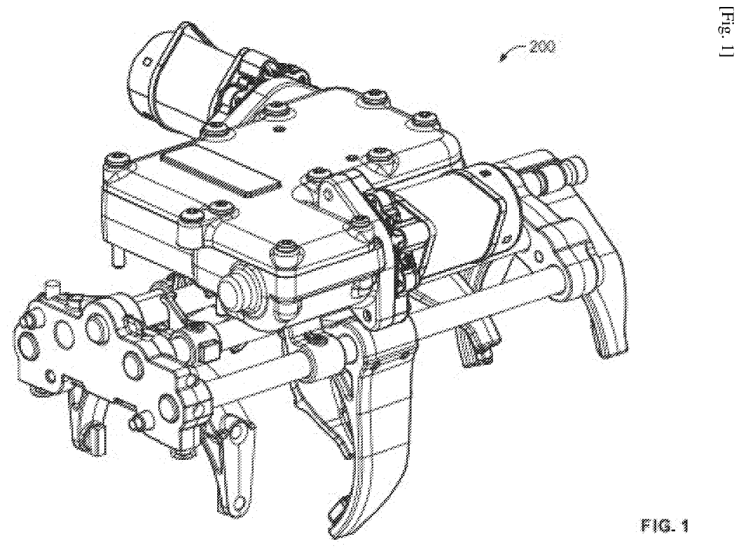

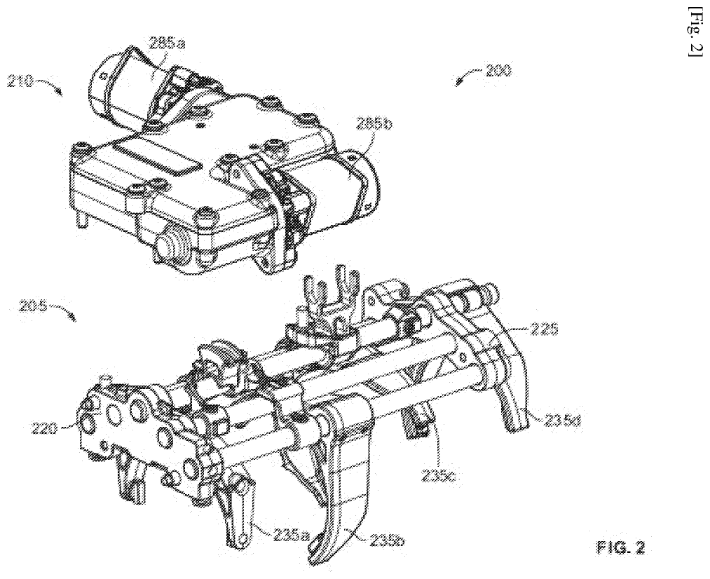

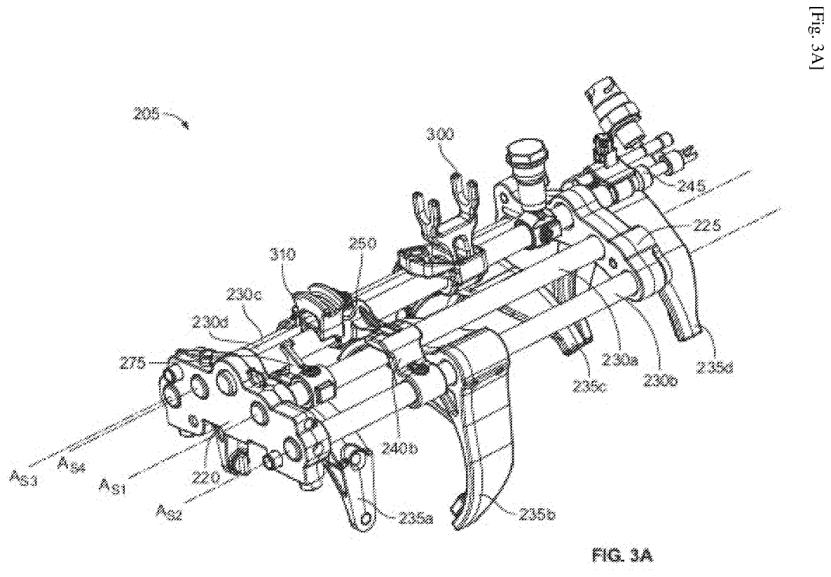

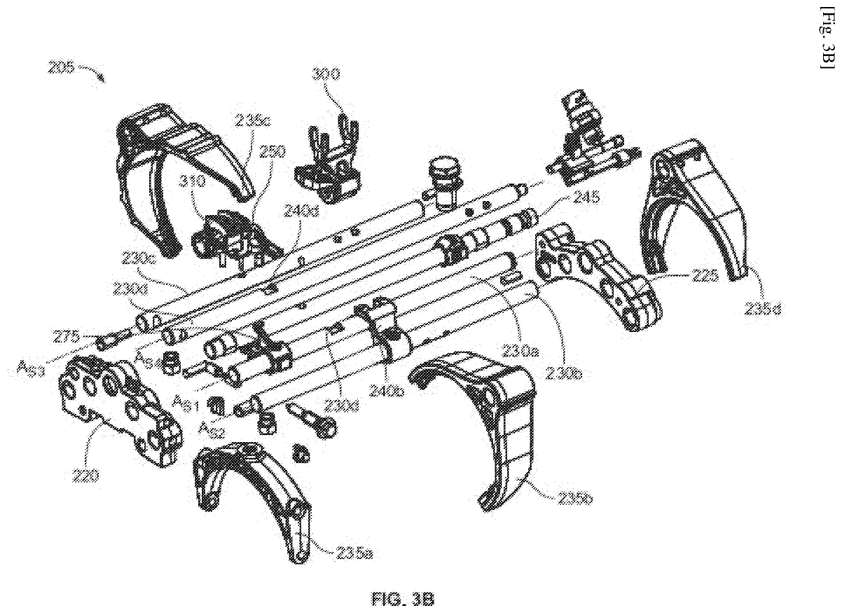

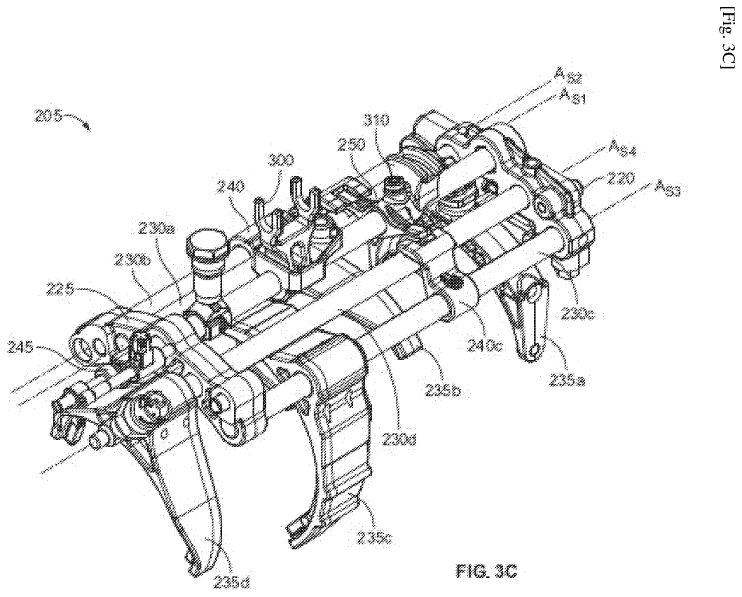

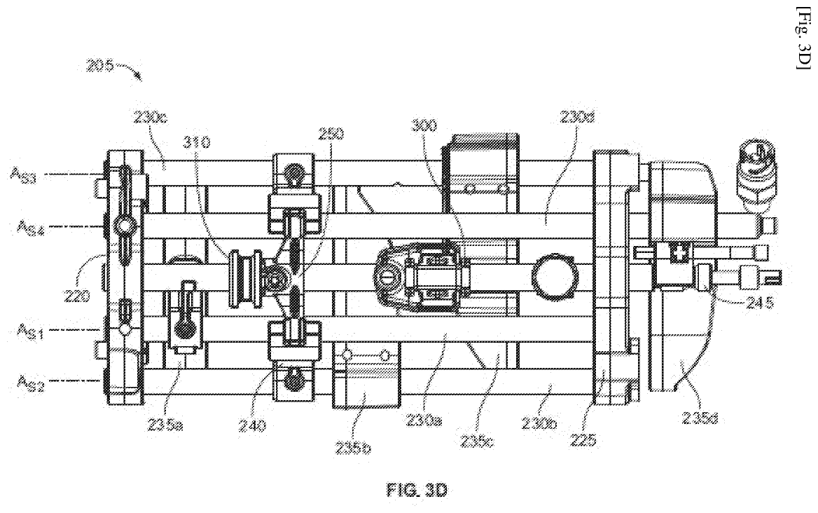

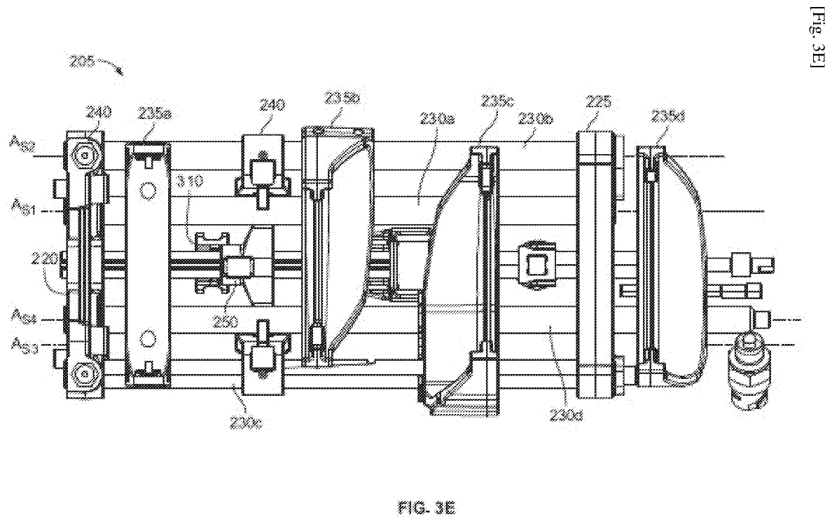

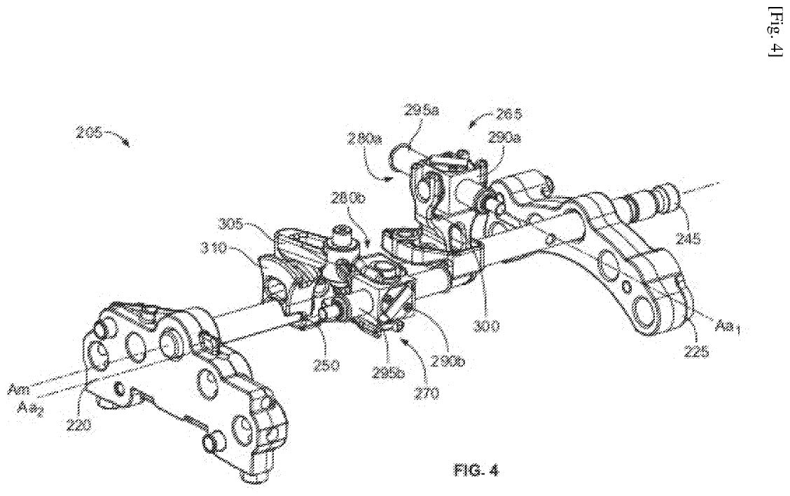

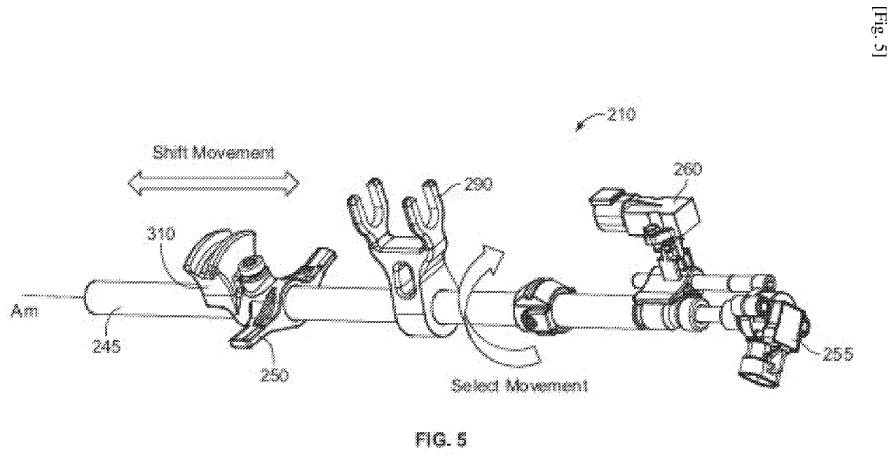

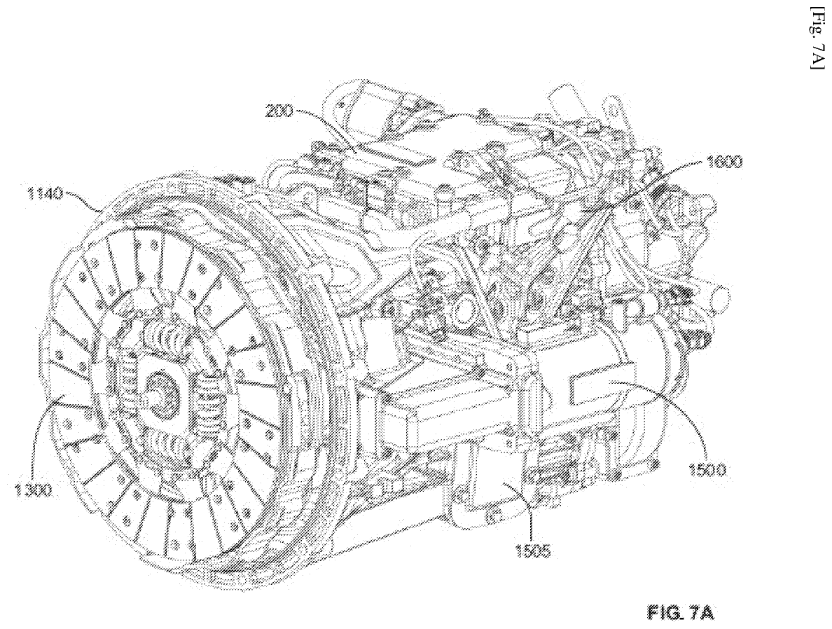

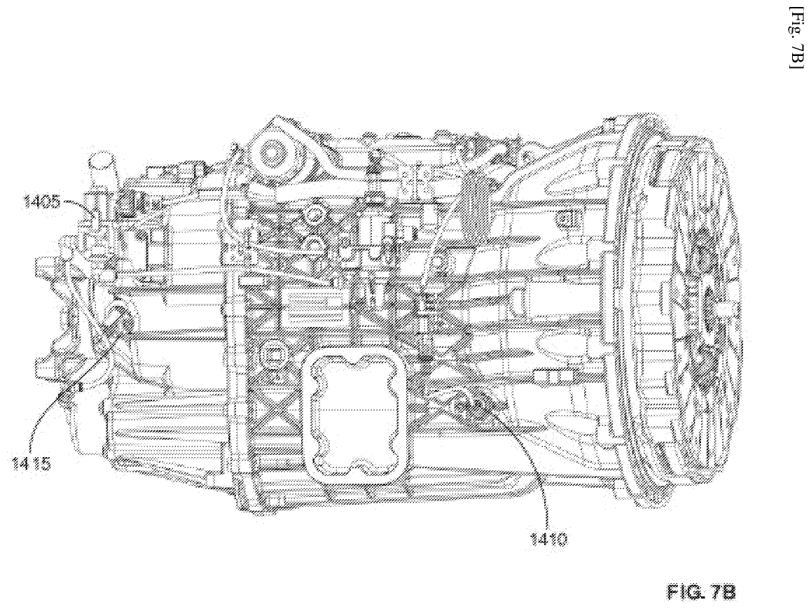

FIGS. 1-6 show an exemplary control system 200 for an automated manual transmission 1100, an exemplary embodiment of which is shown in FIGS. 7-13. According to one example embodiment, the automated manual transmission 1100 can provide six forward speeds and has a torque capacity of at least 610 Newton-meters. In alternative embodiments, the automated manual transmission may include a greater or fewer number of forward speeds or may have a larger or smaller torque capacity.

With reference to FIGS. 7-13, the automated manual transmission 1100 includes an input gear 1105 permanently fixed for rotation with an input shaft 1110, a plurality of intermediate gears 1115a, 1115b, 1115c, 1115d, 1115e, 1115f, 1115g permanently fixed for rotation with a layshaft 1120, and a plurality of output gears 1125a, 1125b, 1125c, 1125d, 1125e, 1125f that are selectively fixed for rotation with an output shaft 1130. In the illustrated embodiment, intermediate gears 1115a, 1115b, 1115c, 1115d are formed separately and subsequently mounted on the layshaft 1120 while intermediate gears 1115e, 1115f, 1115g are formed integrally on the layshaft 1120. In alternative embodiments, any one or more of the intermediate gears may be formed separately and subsequently mounted on the layshaft or formed integrally on the layshaft.

The input gear 1105 is in constant mesh with a first one of the plurality of intermediate gears 1115a and the remainder of the plurality of intermediate gears 1115b, 1115c, 1115d, 1115e, 1115f are in constant mesh with one of the plurality of output gears 1125a, 1125b, 1125c, 1125d, 1125e. Additionally, intermediate gear 1115g is in communication with output gear 1125f via an idler gear (not shown) as is known in the art to provide a reverse gear.

As understood by those of ordinary skill in the art, a desired gear ratio may be provided by selectively locking one of the output gears 1125a, 1125b, 1125c, 1125d, 1125e, 1125f for rotation with the output shaft 1130 or selectively locking the input shaft 1110 directly to the output shaft 1130. The automated manual transmission 1100 may include speed sensors 1410, 1415 that are configured to monitor the rotation speeds of the input shaft 1110 and the output shaft 1130, respectively.

In alternative embodiments, the automated manual transmission may have a fewer or greater number of intermediate gears, a fewer or greater number of output gears, or a greater number of layshafts. In other alternative embodiments, the input gear may not be in constant mesh with one of the plurality of intermediate gears or the intermediate gears may not be in constant mesh with one of the plurality of output gears.

A plurality of gear engagement clutches 1135a, 1135b, 1135c, 1135d selectively lock the output gears 1125a, 1125b, 1125c, 1125d, 1125e, 1125f for rotation with the output shaft 1130 without the use of synchronizers. Additionally, a first one of the plurality of gear engagement clutches 1135a selectively locks the input shaft 1110 directly to the output shaft 1130. Each gear engagement clutch 1135a, 1135b, 1135c, 1135d is permanently fixed for rotation with the output shaft 1130 and is axially movable along the length of the output shaft 1130.

In the illustrated embodiment, each one of the gear engagement clutches 1135a, 1135b, 1135c, 1135d is a dog clutch. As understood by those of ordinary skill in the art, a dog clutch utilizes interlocking teeth (i.e., “dogs”) to couple rotating components. This is in comparison to friction clutches which, as the name implies, rely on friction to couple rotating components.

In alternative embodiments, the automated manual transmission may use other types of gear engagement clutches or may include a fewer or greater number of gear engagement clutches. In other alternative embodiments, the gear engagement clutches may utilize synchronizers to facilitate the process of selectively locking the output gears for rotation with the output shaft.

The foregoing components and other components of the automated manual transmission 1100 are mounted inside a two-piece enclosure 1140 and lubricated using a splash type arrangement. In alternative embodiments, the enclosure may include a fewer or greater number of pieces. In other alternative embodiments, lubrication may be pressurized or provided by a pump, or lubrication may be provided using any other suitable arrangement.

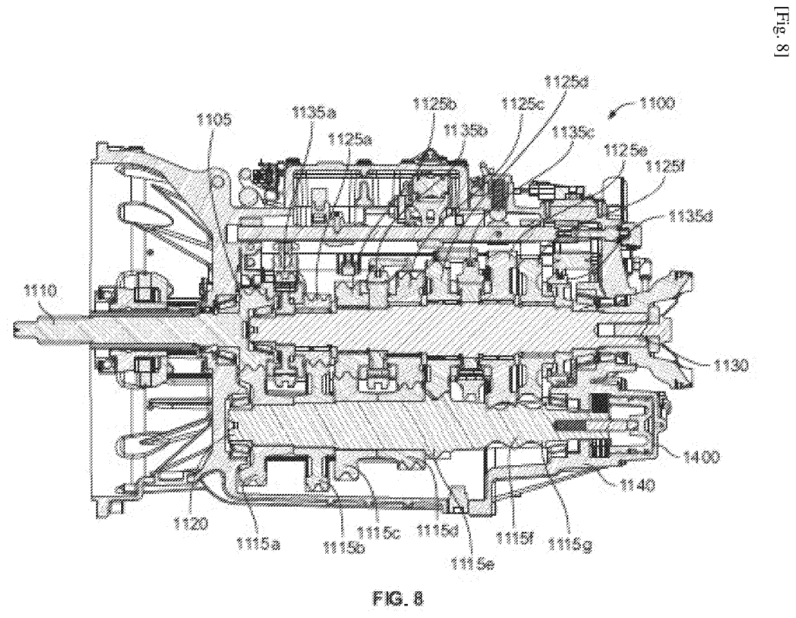

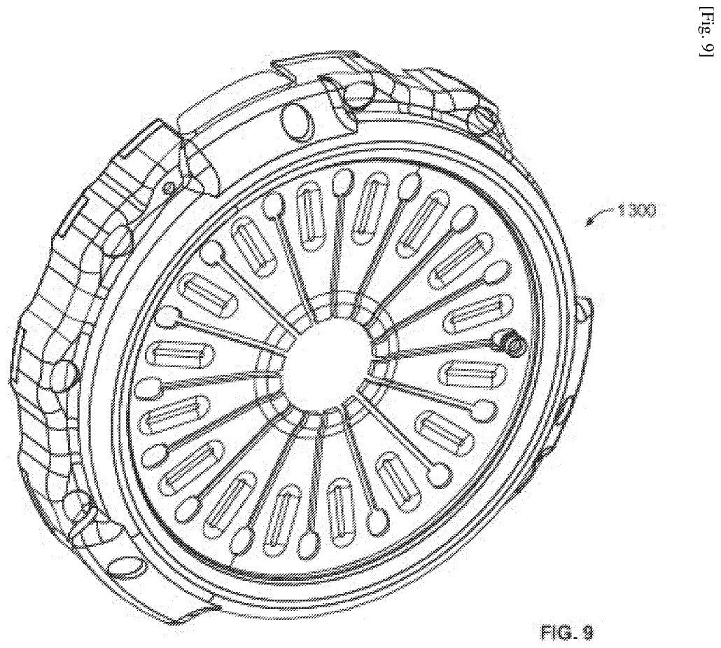

FIG. 9 shows an exemplary embodiment of a primary clutch 1300 for use with the automated manual transmission 1100 of FIGS. 7A, 7B, and 8. The primary clutch 1300 selectively couples the automated manual transmission 1100 to a motive source (e.g., diesel engine, gasoline engine, electric motor, hybrid arrangement). In particular, the primary clutch 1300 selectively couples the motive source to the input shaft 1110. According to one example embodiment, the primary clutch 1300 includes a 362 mm clutch disc that utilizes an SAE3 or SAE2 housing. In other alternative embodiments, the primary clutch may use a larger or smaller clutch disk or may utilize any desired housing. For example, the primary clutch may utilize an SAE1 housing.

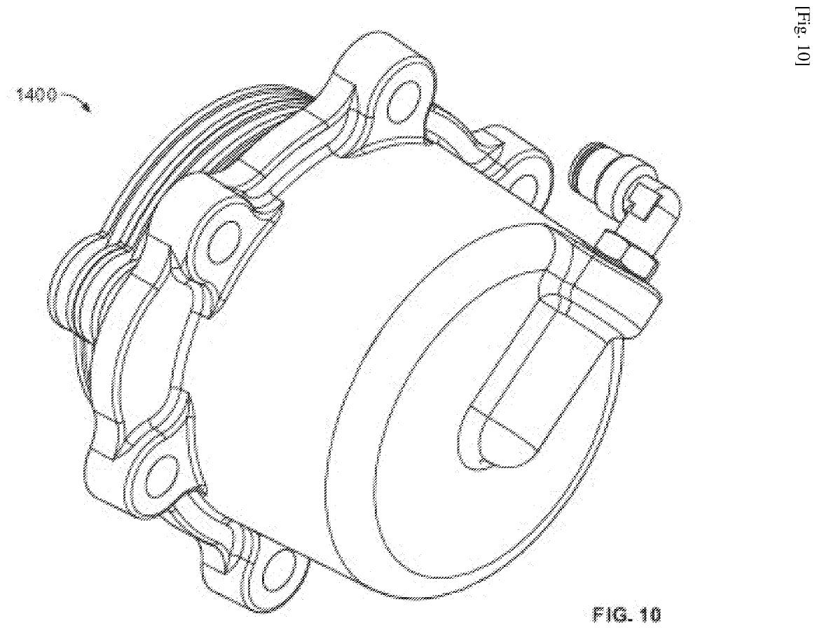

FIG. 10 shows an exemplary embodiment of an inertia brake 1400 for use with the automated manual transmission 1100 of FIGS. 7A, 7B, and 8. As discussed above, the automated manual transmission 1100 does not utilize synchronizers. Instead, the inertia brake 1400 facilitates upshifting by slowing rotation of parts of the automated manual transmission 1100 or the motive source. In alternative embodiments, the automated manual transmission may utilize synchronizers in combination with the inertia brake. In other alternative embodiments, the automated manual transmission may use any desired arrangement to slow rotation of parts of the automated manual transmission to facilitate upshifting.

In the illustrated embodiment, the inertia brake 1400 is configured to slow rotation of the layshaft 1120, is actuated pneumatically, and is lubricated by oil splash generated by the gears in the automated manual transmission 1100. According to one example embodiment, the inertia brake 1400 utilizes EATON® E73 friction material and includes an electro valve 1405.

In alternative embodiments, the inertia brake may be configured to slow rotation of other parts of the automated manual transmission. In other alternative embodiments, the inertia brake may be actuated using any desired arrangement. For example, the inertia brake may be electrically actuated using a solenoid. In still other alternative embodiments, the inertia brake may be lubricated using a pump or any other desired arrangement. In yet other alternative embodiments, the inertia brake may use any desired friction material. In still yet other alternative embodiments, the inertia brake may rely on an electromagnetic braking type arrangement rather than friction material.

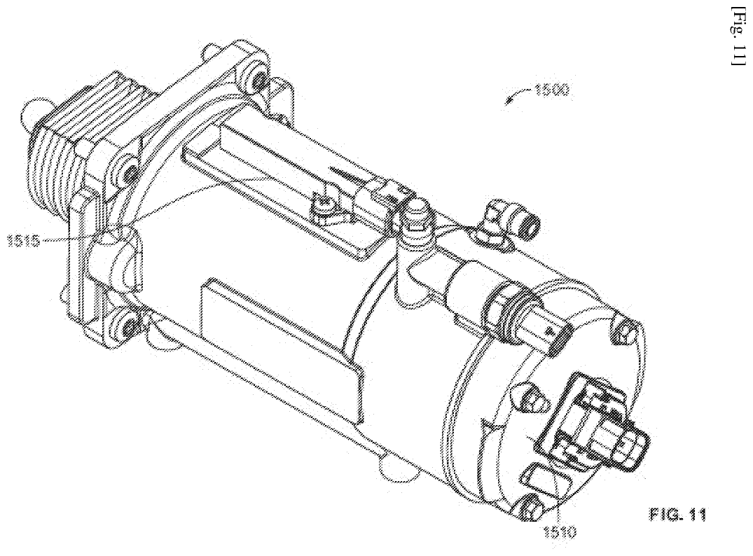

FIG. 11 shows an exemplary embodiment of a pneumatic linear clutch actuator 1500 for use with the automated manual transmission 1100 of FIGS. 7A, 7B, and 8. The pneumatic linear clutch actuator 1500 is configured to actuate the primary clutch 1300 to selectively couple or decouple the automated manual transmission 1100 to the motive source. The pneumatic linear clutch actuator 1500 may be controlled using integrated inlet and exhaust valves 1 510 and an integrated position sensor 1515. In alternative embodiments, the inlet valve, the exhaust valve, or the position sensor may not be integrated. In other alternative embodiments, the primary clutch may be actuated using any desired arrangement. For example, the primary clutch may be actuated using an electric or hydraulic arrangement.

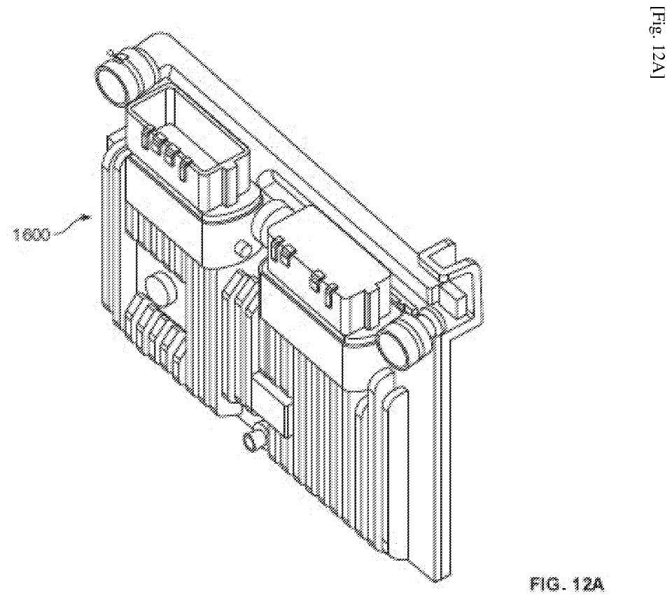

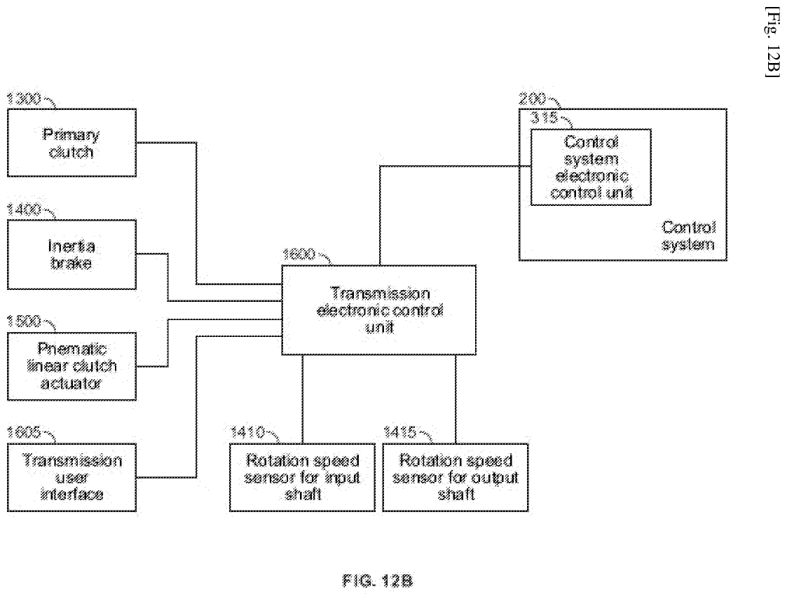

FIG. 12A shows an exemplary embodiment of a transmission electronic control unit 1600 for use with the automated manual transmission 1100 of FIGS. 7A, 7B, and 8. The transmission electronic control unit 1600 controls various components of the automated manual transmission 1100 to provide a desired gear ratio. As shown in FIG. 12B, the transmission electronic control unit 1600 is in communication with the primary clutch 1300, the inertia brake 1400, and the pneumatic linear clutch actuator 1500 to provide control thereof during operation of the vehicle. Furthermore, the transmission electronic control unit 1600 is in communication with the rotation speed sensor 1410 for the input shaft 1110 and the rotation speed sensor 1415 for the output shaft 1130 to refine control of the various components of the automated manual transmission 1100. Additionally, as discussed further below, the transmission electronic control unit 1600 is in communication with the control system electronic control unit 315 of the control system 200. The transmission electronic control unit 1600 is also in communication with a transmission user interface 1605 (e.g., shift lever or shift knob), which an operator uses to select a desired gear ratio.

In alternative embodiments, the transmission electronic control unit may be in communication with or may be in control of a greater or fewer number of components of the automated manual transmission. In other alternative embodiments, the transmission user interface may be any desired arrangement. For example, the transmission user interface may utilize push buttons or a selector key.

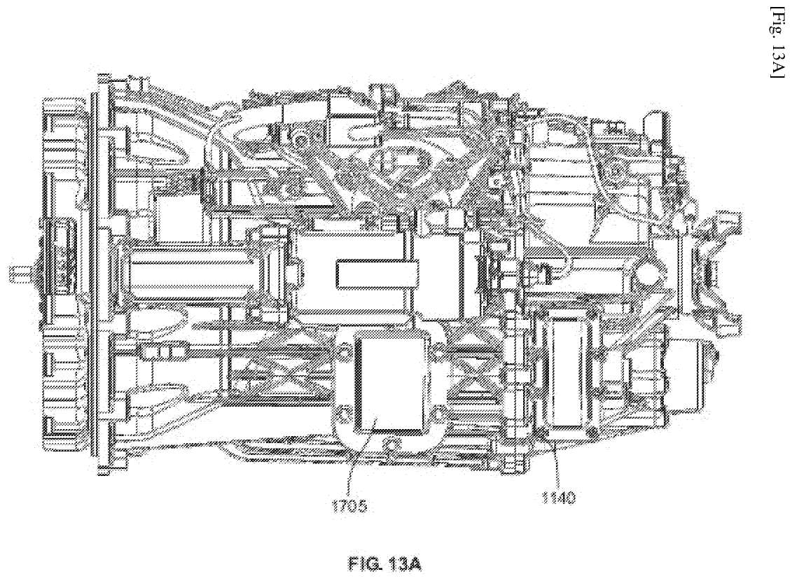

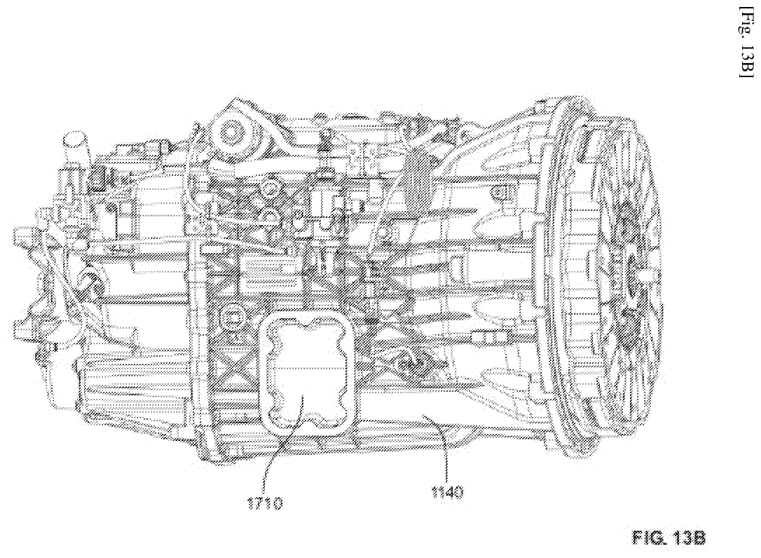

As shown in FIGS. 13A and 13B, the automated manual transmission 1100 includes two power take off unit mounting points 1705, 1710 provided on opposite sides of the enclosure 1140. This arrangement allows a power take off unit to be installed on the left side of the automated manual transmission 1100 or on the right side of the automated manual transmission 1100. Known automated manual transmissions allow a power take off unit to be installed only on the left side or only on the right side of the transmission, but not both. In alternative embodiments, the automated manual transmission may include a greater number of power take off unit mounting points. In other alternative embodiments, the power take off unit mounting points may be provided at any desired location on the enclosure.

Turning now to the control system 200, with reference to FIGS. 1-6, the control system includes a base box 205 and an x-y shifter 210. The base box 205 includes a front support 220 and a rear support 225 that hold a plurality of shift rails 230a, 230b, 230, 230d. Each shift rail 230a, 230b, 230c, 230d is independently translatable (i.e., one shift rail can move while the other two remain stationary) along a respective longitudinal axis Aₛ₁, Aₛ₂, Aₛ₃, Aₛ₄. A shift fork 235a, 235b, 235c, 235d is mounted on a respective one of the shift rails 230a, 230b, 230c, 230d for movement therewith. As understood by those of ordinary skill in the art, each shift fork 235a, 235b, 235c, 235d is connected to one of the respective gear engagement clutches 1135a, 1135b, 1135c, 1135 d in the automated manual transmission 1100. Thus, movement of one of the shift rails 230a, 230b, 230c, 230d ultimately causes movement of one of the gear engagement clutches 1135a, 1135b, 1135c, 1135 d by way of a respective shift fork 235a, 235b, 235c, 235d.

In alternative embodiments, the base box may include a fewer or greater number of shift rails. In other alternative embodiments, the base box may include a fewer or greater number of supports or the supports may be omitted. In yet other alternative embodiments, one or more of the shift forks may be connected to a different part of the automated manual transmission. In still other alternative embodiments, one or more of the shift forks may be omitted.

The x-y shifter 210 is configured to translate the shift rails 230a, 230b, 230c, 230d along their respective longitudinal axes Aₛ₁, Aₛ₂, Aₛ₃, Aₛ₄. The x-y shifter 210 includes a master rail 245 that is held by the front support 220 and the rear support 225 of the base box 205. An ear portion 250 is mounted on the master rail 245.

The master rail 245 can be rotated about its longitudinal axis Aₘ and can also be translated along its longitudinal axis Aₘ. The longitudinal axis Aₘ of the master rail extends substantially parallel with each one of the longitudinal axes Aₛ₁, Aₛ₂, Aₛ₃, Aₛ₄ of the shift rails 230a, 230b, 230c, 230d.

In alternative embodiments, the x-y shifter may include more than one master rail. In other alternative embodiments, the longitudinal axis of the master rail may extend at a nonparallel angle with respect to any one of the longitudinal axes of the shift rails.

Rotating the master rail 245 about its longitudinal axis Aₘ is a “selection action,” and translating the master rail 245 along its longitudinal axis Aₘ is a “shift action.” The x-y shifter 210 includes a rotational movement sensor 255 and a linear movement sensor 260 that are both configured to monitor the position of the master rail 245.

The rotational movement sensor 255 monitors the rotational position of the master rail 245 about its longitudinal axis Aₘ, and the linear movement sensor 260 monitors the translation of the master rail 245 along its longitudinal axis Aₘ. In alternative embodiments, the rotational position of the master rail or the translation of the master rail may be monitored using any desired arrangement. For example, the rotational position or the translation of the master rail may be monitored utilizing one or more magnetic position sensors. In alternative embodiments, the rotational movement sensor or the linear movement sensor may be omitted.

When the master rail 245 rotates about its longitudinal axis Aₘ, the ear portion 250 moves into engagement with one of a plurality of lugs 240a, 240b, 240c, 240d that are mounted on a respective one of the shift rails 230a, 230b, 230c, 230d. Translating the master rail 245 along its longitudinal axis Aₘ causes likewise translation of the ear portion 250. This movement of the ear portion 250 is transferred to one of the shift rails 230a, 230b, 230c, 230d via one of the respective lugs 240a, 240b, 240c, 240d, thereby causing that shift rail to translate along its respective longitudinal axes Aₛ₁, Aₛ₂, Aₛ₃, Aₛ₄. Shift rail 230a includes a stabilizer 275 mounted thereon that engages with the master rail 245. The stabilizer 275 prevents rotation of shift rail 230a such that shift rail 230a is limited to translational movement.

In the illustrated embodiment, lugs 240b, 240c are provided as arms that are attached to shift rail 230b, 230c, respectively, and lugs 240a, 240d are provided as notches formed in shift rails 230a, 230d, respectively. In alternative embodiments, any one or more of the lugs may be provided as arms that are attached to a respective shift rail or as notches formed in a respective shift rail. In other alternative embodiments, the translation of the master rail may be transferred to one of the shift rails using any desired arrangement. In still other alternative embodiments, one or more of the shift rails may include a stabilizer or the stabilizer maybe omitted.

A first actuator 265 performs the selection action and a second actuator 270 performs the shift action. The first and second actuators 265, 270 each include a ball and screw mechanism 280a, 280b and an electric motor 285a, 285b. Each ball and screw mechanism 280a, 280b includes a ball nut 290a, 290b mounted on a respective screw shaft 295a, 295b. The screw shafts 295a, 295b are attached to a respective one of the electric motors 285a, 285b. The electric motors 285a, 285b rotate the respective screw shaft 295a, 295b, thereby causing linear movement of the associated ball nut 290a, 290b. In alternative embodiments, the first or second actuators may have any desired arrangement. For example, the first or second actuators may include a gear train rather than a ball and screw mechanism.

The first actuator 265 includes a selection lever 300 that is attached to the master rail 245. The selection lever 300 is engaged with the ball nut 290a and transforms the linear movement of the ball nut 290a to rotational movement that causes the master rail 245 to rotate about its longitudinal axis Aₘ. A longitudinal axis Aₐ₁ of the screw shaft 295a of the first actuator 265 extends substantially perpendicular to the longitudinal axis Aₘ of the master rail 245. In alternative embodiments, the longitudinal axis of the screw shaft of the first actuator may extend at any desired angle relative to the longitudinal axis of the master rail.

The second actuator 270 includes a shift lever 305 and a shift selector 310. The shift lever 305 is attached to the ball nut 290b and engages with the shift selector 310, which is attached to the master rail 245. Linear movement of the ball nut 290b is transferred to the master rail 245 via the shift lever 305 and the shift selector 310 assembly, thereby causing the master rail 245 to translate along its longitudinal axis Aₘ. A longitudinal axis Aₐ₂ of the screw shaft 295b of the second actuator 270 extends substantially parallel with the longitudinal axis Aₘ of the master rail 245. In alternative embodiments, the longitudinal axis of the screw shaft of the first actuator may extend at any desired angle relative to the longitudinal axis of the master rail.

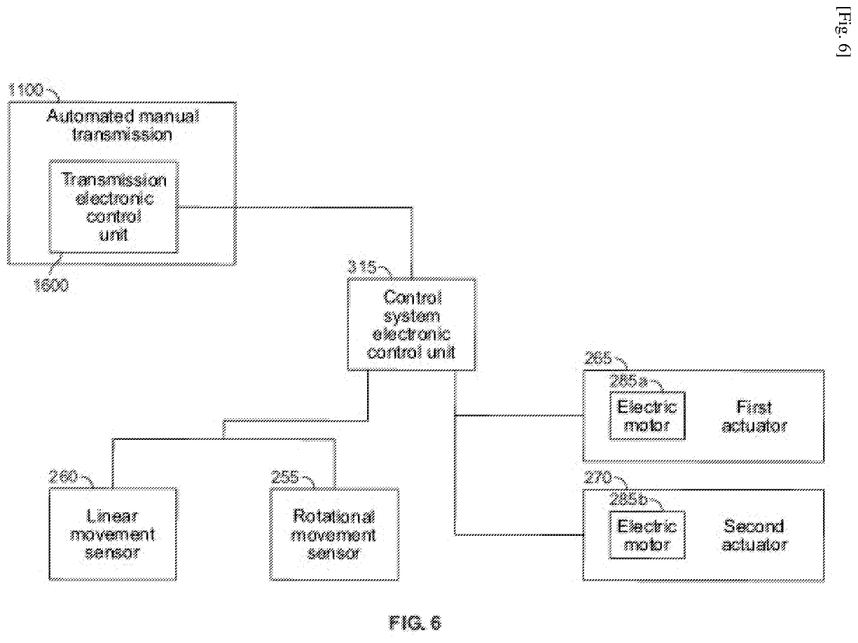

As shown in FIG. 6, a control system electronic control unit 315 is in communication with the transmission electronic control unit 1600 of the automated manual transmission 1100, the electric motor 285a of the first actuator 265, the electric motor 285b of the second actuator 270, the rotational movement sensor 255, and the linear movement sensor 260. The control system electronic control unit 315 controls the first and second actuators 260, 270 to provide a desired gear ratio, as explained further below.

In alternative embodiments, the control system electronic control unit may be integrated with the electronic control unit of the automated manual transmission. In other alternative embodiments, the control system electronic control unit may be in communication with or may be in control of a greater or fewer number of components of the automated manual transmission.

In use, an operator signals that he or she wishes to select a desired gear via the transmission user interface 1605. This input is sensed by the transmission electronic control unit 1600, which sends a signal to the control system electronic control unit 315.

The control system electronic control unit 315 initiates a gear shift by first executing the selection action. The selection action is performed by sending power to the electric motor 285a of the first actuator 265, thereby causing the master rail 245 to rotate about its longitudinal axis Aₘ via the screw shaft 295a, the ball nut 290a, and the selection lever 300 connection described above. The electric motor 285a of the first actuator 265 continues to rotate until the ear portion 250 is brought into engagement with one of the lugs 240a, 240b, 240c, 240d on the respective shift rail 230a, 230b, 230c, 230d that is associated with the gear selected by the operator. The selection action is then complete and power to the electric motor 285a is cut to stop further rotation of the master rail 245 about its longitudinal axis Aₘ. The rotational position of the master rail 245 may be monitored or verified by the rotational movement sensor 255 to ensure that the ear portion 250 has engaged a desired lug of the lugs 240a, 240b, 240c, 240d. For the purposes of this explanation, it is assumed that the ear portion 250 is engaged with the first lug 240a.

Once the selection action is complete, the control system electronic control unit 315 performs the shift action by sending power to the electric motor 285b of the second actuator 270, thereby causing the master rail 245 to translate along its longitudinal axis Aₘ via the screw shaft 295b, the ball nut 290b, the shift lever 305, and the shift selector 310 connection described above. As also described above, translating the master rail 245 along its longitudinal axis Aₘ causes movement of the dog clutch associated with the gear selected by the operator via the ear portion 250 and one of the lugs 240a, 240b, 240c, 240d and associated shift rail 230a, 230b, 230c, 230d. As discussed above, for the purposes of this explanation, it is assumed that the ear portion 250 is engaged with the first lug 240a. Accordingly, the foregoing process would cause translation of the first shift rail 230a along its longitudinal axes Aₛ₁. It is understood, however, that the foregoing process would cause similar movement of the second or third shift rails 230b, 230c, 230d if the ear portion 250 was moved into engagement with the second lug 240b, third lug 240c, or fourth lug 240d, respectively, during the selection action.

The electric motor 285b of the second actuator 270 continues to rotate until the gear engagement clutch engages with the gear corresponding to the gear selected by the operator, thereby fixing the desired gear for rotation with the output shaft.

The shift action is then complete and power to the electric motor 285b is cut to stop further translation of the master rail 245 along its longitudinal axis Aₘ. The automated manual transmission 100 is now in the gear selected by the operator. The linear position of the master rail 245 may be monitored or verified by the linear movement sensor 260 to assess whether the gear engagement clutch has engaged the desired gear.

The foregoing describes a gear shift in general, which may be an upshift or a downshift. In the case of an upshift, prior to shifting, the transmission electronic control unit 1600 actuates the pneumatic linear clutch actuator 1500 to decouple the primary clutch 1300 from the motive source. The electronic control unit 1600 also commands the electro valve 1405 to actuate the inertia brake 1400 to slow rotation of the layshaft 1120 to facilitate shifting. The speed sensors 1410, 1415 monitor input and output rotation speeds to further facilitate the upshift process. In the case of a downshift, the inertia brake 1400 is not utilized but, instead, shifting is facilitated using the transmission electronic control unit 1600 to control the speed of the motive source.

The automated manual transmission 1100 and control system 200 disclosed herein provides several advantages over known arrangements. For example, using the inertia brake 1400 rather than synchronizers reduces cost and increases durability. As another example, using the linear pneumatic actuator 1500 rather than a linear hydraulic actuator further reduces cost. As yet another example, providing two power take off unit mounting points 1705, 1710 on opposite sides of the enclosure 1140 provides increased flexibility over automated manual transmissions that provide a power take off unit mounting point on only a single side. As still yet another example, the control system 200 reduces complexity, cost, and size compared to known control systems. Thus, the automated manual transmission 1100 disclosed herein advantageously reduces cost, complexity, and size while also increasing durability and flexibility compared to known automated manual transmissions. Additionally, compared to known control systems for automated manual transmissions, the control system 200 disclosed herein advantageously decreases complexity, expense, and size.

With regard to the control system 200, the arrangement disclosed herein reduces the height of the x-y shifter 210 by approximately 32% compared to known electrically actuated x-y shifters and by approximately 43% compared to known hydraulically actuated x-y shifters. According to one example, the x-y shifter 210 has a height of 63 mm, in comparison to a height of 93 mm for an equivalent known electrically actuated x-y shifter and a height of 111 mm for an equivalent known hydraulically actuated x-y shifter.

Without excluding further possible embodiments, certain example embodiments are summarized in the following example clauses.
Example clause 1: a control system for an automated manual transmission, the control system comprising: a base box comprising a plurality of shift rails configured to move a respective one of a plurality of gear engagement clutches of the automated manual transmission, each one of the plurality of shift rails extending along a respective shift rail longitudinal axis; and an x-y shifter comprising: a master rail extending along a master rail longitudinal axis, a first actuator configured to rotate the master rail about the master rail longitudinal axis, and a second actuator configured to translate the master rail along the master rail longitudinal axis; wherein rotating the master rail about the master rail longitudinal axis causes the master rail to engage with one of the plurality of shift rails, and wherein translating the master rail along the master rail longitudinal axis causes the master rail to move the one engaged shift rail of the plurality of shift rails along its respective shift rail longitudinal axis.
Example clause 2: the control system of example clause 1, wherein the first actuator includes a first ball nut connected to the master rail and a first screw shaft connected to a first electric motor.
Example clause 3: the control system of example clause 1 or 2, wherein the first screw shaft extends along a screw shaft longitudinal axis, and wherein the screw shaft longitudinal axis is substantially perpendicular to the master rail longitudinal axis.
Example clause 4: the control system of any of example clauses 1-3, wherein the first actuator includes a selection lever that is attached to the master rail and engaged with the first ball nut, the selection lever transforming linear movement of the first ball nut to rotational movement that causes the master rail to rotate about the master rail longitudinal axis.
Example clause 5: the control system of any of example clauses 1-4, wherein the second actuator includes a second ball nut connected to the master rail and a second screw shaft connected to a second electric motor.
Example clause 6: the control system of any of example clauses 1-5, wherein the second actuator includes a shift lever attached to the second ball nut and a shift selector attached to the master rail, the shift lever and the shift selector transferring linear movement of the second ball nut to the master rail to cause the master rail to translate along the master rail longitudinal axis.
Example clause 7: the control system of any of example clauses 1-6, wherein each one of the plurality of shift rails has a lug mounted thereon and the master rail has an ear portion mounted thereon, and wherein rotating the master rail about the master rail longitudinal axis causes the ear portion to engage with one of the plurality of lugs.
Example clause 8: the control system of any of example clauses 1-7, wherein each one of the plurality of shift rails has a shift fork mounted thereon, each one of the plurality of shift forks being configured to engage with a respective one of the plurality of gear engagement clutches, and wherein translating the master rail along the master rail longitudinal axis causes one of the plurality of shift forks to move a respective one of the plurality of gear engagement clutches.
Example clause 9: the control system of any of example clauses 1-8, further comprising a rotational movement sensor configured to monitor rotation of the master rail about the master rail longitudinal axis.
Example clause 10: the control system of any of example clauses 1-9, further comprising a linear movement sensor configured to monitor translation of the master rail along the master rail longitudinal axis.
Example clause 11: a method of shifting an automated manual transmission having a plurality of gear engagement clutches, the method comprising the steps of: providing a base box and an x-y shifter, the base box comprising a plurality of shift rails configured to move a respective one of the plurality of gear engagement clutches, each one of the plurality of shift rails extending along a respective shift rail longitudinal axis, the x-y shifter comprising a master rail, a first actuator, and a second actuator; activating the first actuator to rotate the master rail about the master rail longitudinal axis to cause the master rail to engage with one of the plurality of shift rails; and activating the second actuator to translate the master rail along the master rail longitudinal axis to cause the master rail to translate the one engaged shift rail of the plurality of shift rails along its respective shift rail longitudinal axis.
Example clause 12: the method of example clause 11, wherein the first actuator includes a first ball nut connected to the master rail and a first screw shaft connected to a first electric motor.
Example clause 13: the method of example clauses 11 or 12, wherein the first actuator includes a selection lever that is attached to the master rail and engaged with the first ball nut, the selection lever transforming linear movement of the first ball nut to rotational movement that causes the master rail to rotate about the master rail longitudinal axis.
Example clause 14: the method of any of example clauses 11-13, wherein the second actuator includes a second ball nut connected to the master rail and a second screw shaft connected to a second electric motor.
Example clause 15: the method of any of example clauses 11-14, wherein the second actuator includes a shift lever attached to the second ball nut and a shift selector attached to the master rail, the shift lever and the shift selector transferring linear movement of the second ball nut to the master rail to cause the master rail to translate along the master rail longitudinal axis.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present disclosure has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the disclosure, in its broader aspects, is not limited to the specific details, the representative apparatus and method, and illustrative examples shown and described. For example, the control system disclosed herein may be used in any desired automated manual transmission design beyond the one described herein. As another example, the automated manual transmission may utilize any desired control system beyond the one described herein. Accordingly, departures may be made from such details without departing from the spirit or scope of the applicant's general inventive concept.

What is claimed is:

1. A control system for an automated manual transmission, the control system comprising:
a base box comprising a plurality of shift rails configured to move a respective one of a plurality of gear engagement clutches of the automated manual transmission, each one of the plurality of shift rails extending along a respective shift rail longitudinal axis; and
an x-y shifter comprising:
a master rail extending along a master rail longitudinal axis,
a first actuator configured to rotate the master rail about the master rail longitudinal axis, the first actuator including a first ball nut connected to the master rail and a first screw shaft connected to a first electric motor, and
a second actuator configured to translate the master rail along the master rail longitudinal axis, the second actuator including a second ball nut connected to the master rail and a second screw shaft connected to a second electric motor;
wherein rotating the master rail about the master rail longitudinal axis causes the master rail to engage with one of the plurality of shift rails, and wherein translating the master rail along the master rail longitudinal axis causes the master rail to move the one engaged shift rail of the plurality of shift rails along its respective shift rail longitudinal axis.

2. (canceled)

3. The control system of claim 1, wherein the first screw shaft extends along a screw shaft longitudinal axis, and wherein the screw shaft longitudinal axis is substantially perpendicular to the master rail longitudinal axis.

4. The control system of claim 1, wherein the first actuator includes a selection lever that is attached to the master rail and engaged with the first ball nut, the selection lever transforming linear movement of the first ball nut to rotational movement that causes the master rail to rotate about the master rail longitudinal axis.

5. (canceled)

6. The control system of claim 1, wherein the second actuator includes a shift lever attached to the second ball nut and a shift selector attached to the master rail, the shift lever and the shift selector transferring linear movement of the second ball nut to the master rail to cause the master rail to translate along the master rail longitudinal axis.

7. The control system of claim 1, wherein each one of the plurality of shift rails has a lug mounted thereon and the master rail has an ear portion mounted thereon, and wherein rotating the master rail about the master rail longitudinal axis causes the ear portion to engage with one of the plurality of lugs.

8. The control system of claim 1, wherein each one of the plurality of shift rails has a shift fork mounted thereon, each one of the plurality of shift forks being configured to engage with a respective one of the plurality of gear engagement clutches, and wherein translating the master rail along the master rail longitudinal axis causes one of the plurality of shift forks to move a respective one of the plurality of gear engagement clutches.

9. The control system of claim 1 further comprising a rotational movement sensor configured to monitor rotation of the master rail about the master rail longitudinal axis.

10. The control system of claim 1 further comprising a linear movement sensor configured to monitor translation of the master rail along the master rail longitudinal axis.

11. A method of shifting an automated manual transmission having a plurality of gear engagement clutches, the method comprising the steps of:
providing a base box and an x-y shifter, the base box comprising a plurality of shift rails configured to move a respective one of the plurality of gear engagement clutches, each one of the plurality of shift rails extending along a respective shift rail longitudinal axis, the x-y shifter comprising a master rail, a first actuator, and a second actuator, the first actuator including a first ball nut connected to the master rail and a first screw shaft connected to a first electric motor, the second actuator including a second ball nut connected to the master rail and a second screw shaft connected to a second electric motor;
activating the first actuator to rotate the master rail about the master rail longitudinal axis to cause the master rail to engage with one of the plurality of shift rails; and
activating the second actuator to translate the master rail along the master rail longitudinal axis to cause the master rail to translate the one engaged shift rail of the plurality of shift rails along its respective shift rail longitudinal axis.

12. (canceled)

13. The method of claim 11, wherein the first actuator includes a selection lever that is attached to the master rail and engaged with the first ball nut, the selection lever transforming linear movement of the first ball nut to rotational movement that causes the master rail to rotate about the master rail longitudinal axis.

14. (canceled)

15. The method of claim 11, wherein the second actuator includes a shift lever attached to the second ball nut and a shift selector attached to the master rail, the shift lever and the shift selector transferring linear movement of the second ball nut to the master rail to cause the master rail to translate along the master rail longitudinal axis.
